(19) United States
(12) Patent Application Publication
(10) Pub. No.: US 2024/0193550 A1
(43) Pub. Date: Jun. 13, 2024

(54) Matching Platform Without Chat

(71) Applicant: Scott James Avy, Ridgefield, WA (US)

(72) Inventor: Scott James Avy, Ridgefield, WA (US)

(73) Assignee: Scott James Avy, Ridgefield, WA (US)

(21) Appl. No.: 18/460,466

(22) Filed: Sep. 1, 2023

Related U.S. Application Data
(60) Provisional application No. 63/403,148, filed on Sep. 1, 2022.

(51) Int. Cl. G06Q 10/1093; G06F 3/04883; G06Q 50/00; H04L 67/306

(52) U.S. Cl. CPC G06Q 10/1095; G06F 3/04883; G06Q 50/01; H04L 67/306

(57) ABSTRACT

Some embodiments provide for an online matching system and method without a need for chat. In one embodiment, a method receives, from a first user device at a server, one or more screener questions and one or more date and time slots selected by a first user of the first user device. The method also receives one or more selections of user profiles from the first and second devices. The method then determines a match between the first user of the first user device and a second user of the second user device and sends the second user device the one or more screener questions. If the second user passes all of the screener questions, a meeting may then be set up between the first and second users without setting up a chat between the first and second users.

### FIELD OF THE INVENTION

The present disclosure relates generally to online matching platforms, and more particularly to methods, programs, and systems that enables users to match with one another and schedule dates without a chat function.

### BACKGROUND

The online dating process is very inefficient for a number of reasons. First, it takes an inordinate amount of time to secure a date. For example, in one study date seekers spend on average 3 days and 20 hours talking online to someone before going on a date and 39.2% of date seekers spend 1+week talking online to someone before going on a date. Second, in the process of securing a date, users are frequently ghosted. For example, in one study, up to 29.35% of date seekers are ghosted after spending 1 week or more talking with a potential date. Third, users who actually go on a first date see a precipitous drop in their chances at going on a second date. For example, in one study, only 4.85% of date seeker went on a first date that led to a second date. An improved online matching platform is needed.

### BRIEF DESCRIPTION OF THE DRAWINGS

FIG. 1 illustrates a conceptual overview of different stages of the online matching platform according to some embodiments.

FIG. 2A shows an exemplary online matching platform performing exemplary matching and date arranging processes according to some embodiments.

FIG. 2B shows another exemplary online matching platform performing exemplary matching and date arranging processes according to another embodiment.

FIGS. 3A-E show an exemplary user journey for users who want to be screened by other users, according to some embodiments.

FIGS. 4A-E show an exemplary user journey for users who want to screen other users, according to some embodiments.

FIG. 5 shows an exemplary interface for users to select whether they want to screen or be screened by other users, according to some embodiments.

FIGS. 6A-F show exemplary screen captures of the online matching platform mobile application, according to some embodiments.

FIG. 7 shows an overall flow of a matching and scheduling process performed by the online matching platform, according to some embodiments.

FIG. 8 shows another overall flow of a matching and scheduling process performed by the online matching platform, according to other embodiments.

### SUMMARY

Some embodiments provide computer-implemented method of setting up a meeting between a first user and a second user of a mobile application. The method includes receiving, from a first user device at a server, one or more screener questions and one or more date and time slots selected by a first user of the first user device. The method also includes receiving, from the first user device at the server, one or more selections of user profiles. The method then provides for receiving, from a second user device at the server, one or more selections of user profiles. The method also provides for determining, at the server, a match between the first user of the first user device and a second user of the second user device and, in response, sending the second user device the one or more screener questions. If it is determined that responses to the one or more screener questions from the second user device passes a criterion for the one or more screener questions, the method provides for sending a message to the second user requesting an RSVP to the one or more date and time slots. The method further provides for receiving, at the server from the second user device, the RSVP of the second user to one of the one or more date and times of the first user and automatically setting up a meeting between the first user and the second user without setting up a chat between the first user device and the second user device, wherein the meeting is scheduled for the one of the one or more date and times to which the second user RSVP′d. Moreover, the method provides sending, from the server, messages to the first user device and second user device related to the meeting.

In another embodiment, rather than the second user requesting an RSVP to the one or more date and time slots, the method alternatively sends a message to the second user requesting that the second user propose a meeting using the one or more date and time slots. In this embodiment, once the proposed meeting is received from the second user, the proposed meeting may then be forwarded to the first user for the first user to confirm. When the first user confirms that proposed meeting, the method may automatically set up a meeting between the first and second user.

The following detailed description and accompanying drawings provide a better understanding of the nature and advantages of various embodiments of the present disclosure.

### DETAILED DESCRIPTION

In the following description, for purposes of explanation, numerous examples and specific details are set forth in order to provide a thorough understanding of the present disclosure. It will be evident, however, to one skilled in the art that various embodiments of the present disclosure as defined by the claims may include some or all of the features in these examples alone or in combination with other features described below, and may further include modifications and equivalents of the features and concepts described herein.

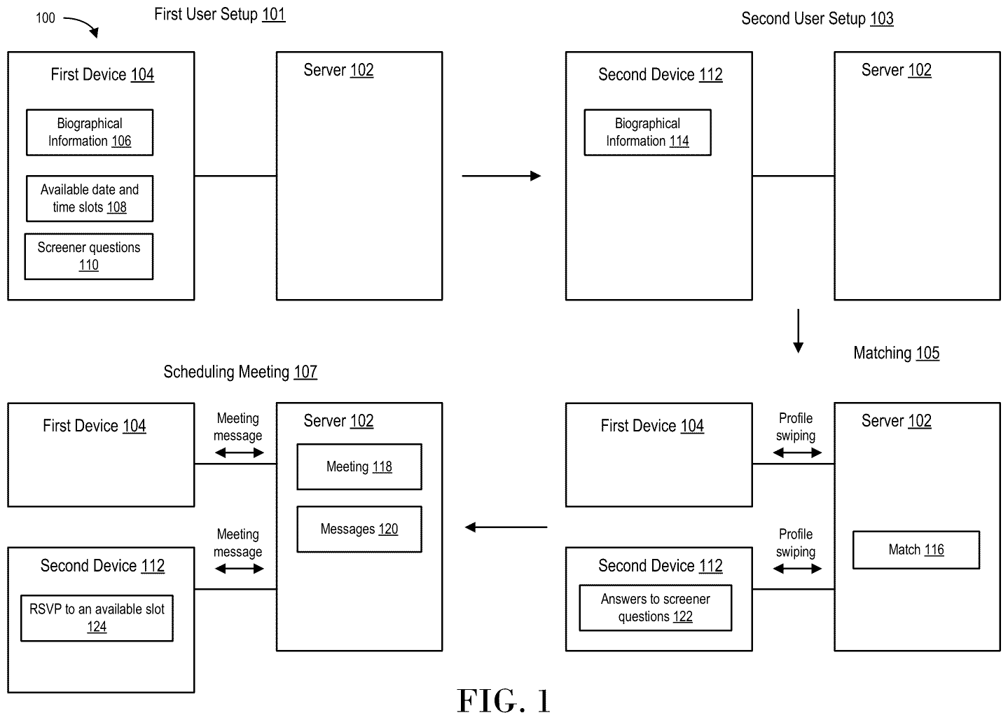

FIG. 1 illustrates a conceptual overview of different stages of the online matching platform 100 according to some embodiments. The stages include first user set up 101, second user set up 103, matching 105, and scheduling meeting 107. In first user set up 101, a first user of first device 104 sets up an account with the online matching platform's server 102. This may occur after the first user downloads the online matching platform's mobile application from a mobile applications store. In the embodiment shown in FIG. 1, the first user may be a woman who will screen other users as opposed to a man who will be screened by other users. As shown, the first user may input biographical information 106, available date and time slots 108, and screener questions 110 as part of their account creation process with the online matching platform. Biographical information 106 may include photos of the first user and personal data such as age, location, gender, education, religion, ethnicity, height, smoking preferences, drinking preferences, job title, a personal statement about what the first user is looking for, among other personal information. Available date and time slots 108 include times that the first user is available to meet with a match. In other words, available date and time slots 108 are slots that the first user can commit to going on dates if someone RSVPs for them.

Screener questions 110 are questions that the first user wishes to use to filter the matched profile pool. The screener questions 110 that the first user chooses will be the questions that any users whom match with the first user must answer favorably to proceed to go on a date with the first user. The screener questions 110 may be chosen from a set of default questions about the religion of the second user or whether the second user drinks or not. While these two questions are shown for illustration, there may be any number of other screener questions 110. Other screener questions 110 may be customized or written in by the user. In addition to screener questions 110, the first user must also specify the favored answer for each question. If the second user answers each screener question favorably, they will be enabled to pick one or more of the available date and time slots 108 for a date.

The next stage in the overall matching and scheduling process is second user setup 103. Similar to the first user setup 101, second user setup 103 includes a second user of second device 112 setting up an account with the online matching platform's server 102. This may occur after the second user downloads the online matching platform's mobile application from a mobile applications store. In the embodiment shown in FIG. 1, the second user may be a man who will be screened by others like the first user as opposed to a woman who will screen others. Additionally, as shown, the second user inputs biographical information 114 to server 102 in a similar manner as in first user set up 101. Similar to the first user of first device 104, second user of second device 112 may upload photos of themselves and personal data such as age, location, gender, education, religion, ethnicity, height, smoking preferences, drinking preferences, job title, a personal statement about what the second user is looking for, among other personal information. This information will be used to create a profile for second user on the online matching platform. As shown, the second user does not input available date and time slots or screener questions. Instead, second user will select from available date and time slots of other users who screens second user.

As shown, the next stage in the matching and scheduling process is matching 105. In this stage, both the first and second users will be provided with various profiles of users, including each other's. The first and second users will swipe or otherwise indicate an approval or disapproval of profiles. In the figure shown, the first user of first device 104 swipes on the profile of the second user of second device 112 and vice versa. As a result, a match 116 between the two is generated at server 102. Once a match 116 is created, the screener questions 110 that first user inputted during first user setup 101 will be forwarded to the second device 112. For example, if the first user inputted a screener question of “do you like dogs?” at first user setup 101, that screener question will then be forwarded to second device 112 with a prompt for the second user to answer the screener question. As shown, second user inputs answers to screener questions 122 into second device, which then gets communicated to server 102 for evaluation. If the second user inputs favorable answers to each screener question 110, then the second user will be enabled to RSVP to an available date and time slot 108 of first user to go on a date. If the second user inputs disfavored answers to screener questions 110 (e.g., the wrong answer), then second user will be filtered out and not enabled to RSVP to an available date and time slot 108 to go on a date. In other words, in some embodiments, the second user must get all the screener questions 110 correct to be able to go on the date with the first user. In other embodiments, the second user may only have to get a certain percentage of the screener questions 110 correct to be able to go on the date with the first user. In still other embodiments, the first user may review the second user's answers and potentially allow an unfavorable answer or a “indifferent” answer.

The next stage in the matching and scheduling process is scheduling meeting 107. Once server 102 determines that the second user correctly answered all of the screening questions 110, server 102 sends available date and time slots 108 that the first user inputted to second device 112. This enables the second user to select a time to go on a date that the first user has already committed for this purpose. As shown, second user RSVPs to an available slot 124 and that is sent to server 102. As a result, server 102 creates meeting 118 at the selected slot in RSVP to an available slot 124.

To prevent either the first or second user from being stood up, messages 120 are sent to first and second device 104 and 112 to request confirmation that they will be attending the meeting 118. If the first and second user intends on attending the meeting 118, they will say so in response to the messages 120. If either the first or second user no longer intends on attending the meeting 118, they can respond accordingly to messages 120. In response, the other user can be notified so that the other user does not show up to the meeting 118 only to be stood up.

Messages 120 are automated messages sent by server 120 and are not messages written by either the first user or second user. In other words, no personal messages are sent between first device and second device in the entire matching and scheduling process. This reduces the chat overhead that users of other platforms need to engage in to reach a meeting 118. In other words, users of the presently disclosed solution are not enabled to chat with persons they match with to reduce the amount of back and forth needed to go on a date. Additionally, the probability of being ghosted in a chat is entirely eliminated because there is no chat functionality. Instead, so long as both users have swiped on each other and one user passes the other's screener questions, the users will be encouraged to meet in person to get to know each other.

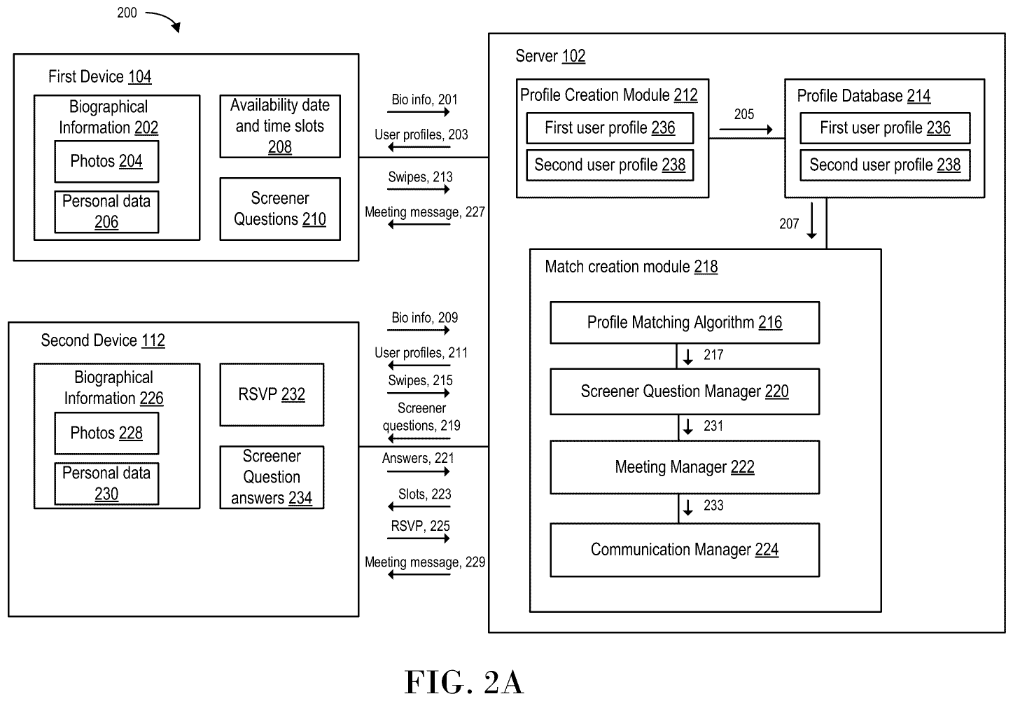

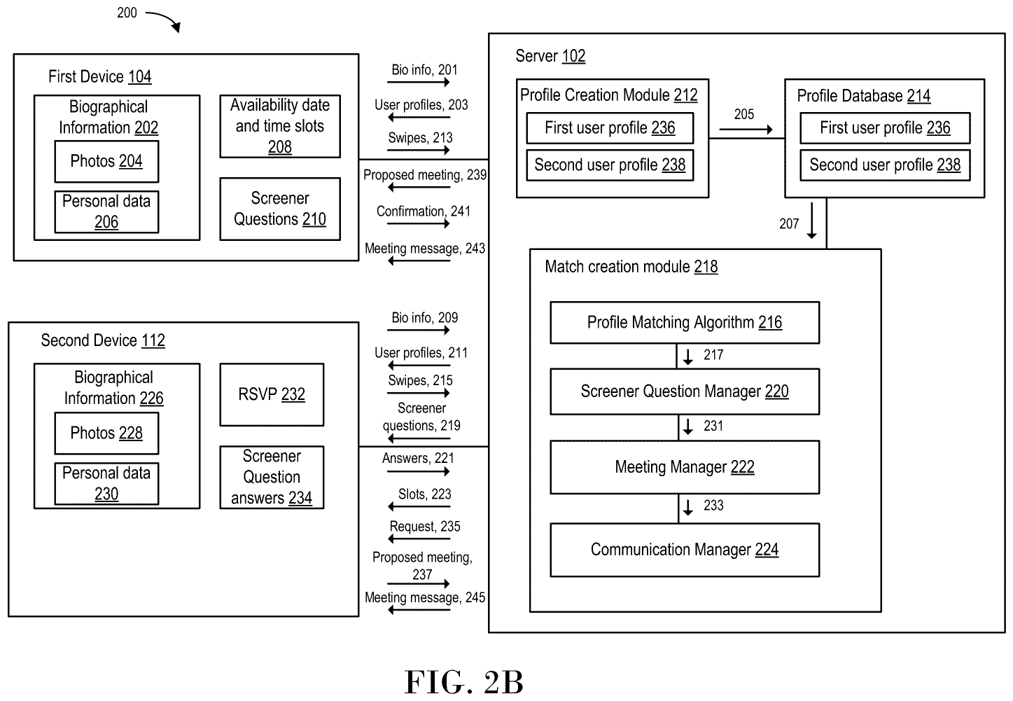

FIG. 2A shows an exemplary online matching platform 200 performing exemplary matching and date scheduling processes according to some embodiments. As shown, the online matching platform includes server 102 in communication with first device 102 and second device 112. When the first user of first device 104 sets up an account with the online matching platform, they enter biographical information 202 such as photos 204 and personal data 206, availability date and time slots 208, and screener questions 210. As noted above, personal data 206 can include information about age, location, gender, education, religion, ethnicity, height, smoking preferences, drinking preferences, job title, a personal statement about what the first user is looking for, among other personal information. The availability date and time slots 208 may be times for which the first user commits ahead of time to going on a date. The first user may be notified that these times may be RSVP′d to by other users with whom they match. Additionally, the first user inputs screener questions 210 that they wish to filter out candidate matches. Screener questions 210 may give the first user some assurances that they can freely go on dates without chatting with people with whom they match. In some sense, the screener questions 210 take the place of a chat. This data is sent at 201 to server 102.

The server 102 receives the biographical information 202, availability date and time slots 208, screener questions 210 and routes them to the profile creation module 212. Profile creation module 212 is responsible for creating profiles for the users. In this scenario, the profile creation module 212 creates a first user profile 236 that includes photos 204 and personal data 206, as well as availability date and time slots 208 and screener questions 210. Once the first user profile 236 for the first user is created, the first user profile 236 is communicated to the profile database 214. Profile database 214 is responsible for storing various profiles for various users.

Second user of second device 112 is also shown to input biographical information 226 like photos 228 and personal data 230. Second device 112 is shown to communicate the biographical information at 209 to server 102. Server 102 routes the biographical information 226 of second user to profile creation module 212, which creates a second user profile 238. Once second user profile 238 is created, the second user profile 238 is sent to the profile database 214.

At 207, both first user profile and second user profile 236-238 are sent to match creation module 218. Match creation module 218 is responsible for sending profiles to users to create an initial match, for managing the screening process, and for managing the meeting scheduling process. Match creation module 218 is shown to include profile matching algorithm 216, screener question manager 220, meeting manager 222, and communication manager 224.

Profile matching algorithm 216 is responsible for feeding both first user and second user different profiles that might be of interest to them. For example, profile matching algorithm 216 sends at 203 and 211 user profiles to first and second devices 104 and 112. In response, first and second users swipe on the profiles that were sent. For example, first and second user may swipe right to indicate they approve or are interested in a profile and may swipe left to indicate they are not interested. Here, first user approves of the second user profile 238 and the second user approves of the first user profile 236. These swipes are communicated at 213 and 215 back to server 102.

Profile matching algorithm 216 detects that there is a match between the first user and the second user and sends both profiles to screener question manager 220 at 217. Screener question manager 220 looks up the screener questions 210 from first user profile 236 and communicates those screener questions 210 to second device 112 and 219. Second device 112 prompts the second user to screener question answers 234 into the second device 112. Once second user inputs screener question answers 234, screener question answers 234 are sent at 221 back to screener question manager 220. If screener question manager 220 detects that the questions are answered correctly in screener question answers 234, screener question manager 220 will move second user to the next stage a 231, which is conducted by meeting manager 222.

Meeting manager 222 is responsible for scheduling the meeting between the first and second users. Specifically, meeting manager 222 sends the availability date and time slots 208 associated with the first user profile 236 to second device 112 at 223. In response, second user may RSVP 232 for one of the availability date and time slots 208. Second device 112 then sends RSVP 232 to server 102 at 225. Once the meeting manager 222 receives the RSVP 232, it creates a meeting between the first and second users. Meeting manager 222 then notifies communication manager 224 of the meeting at 233.

Communication manager 224 is responsible for communicating meeting messages to a first and second device 104 and 112. Specifically, communication manager 224 may send reminder messages about the meeting. Communication manager 224 may also send requests for confirmation that the first and second users will show up to the meeting. If communication manager 224 receives a message or a lack of a confirmation by either the first or second user prior to the date, the communication manager will notify the other user so that they don't show up. In this way, the online matching platform prevents users from being stood up.

FIG. 2B shows another exemplary online matching platform performing exemplary matching and date arranging processes according to another embodiment. In this embodiment, rather than the second user RSVPing (e.g., at 225 in FIG. 2A), server 102 sends a request to second device 112 prompting the user of the second device to propose a meeting time and location based on the first user's preference. The proposed meeting 237 is then sent from second device 112 to server 102, which then forwards the proposed meeting 239 to first device 104. At this point, the user of the first device 104 may confirm 241 that the proposed meeting is amenable to them. Otherwise, the user of the first device 104 may propose an alternate time and location. Here, the user of the first device confirms 241 that the proposed meeting 239 works for them. Server 102 then automatically creates the meeting at the proposed date and time between the first and second users without setting up a chat between them.

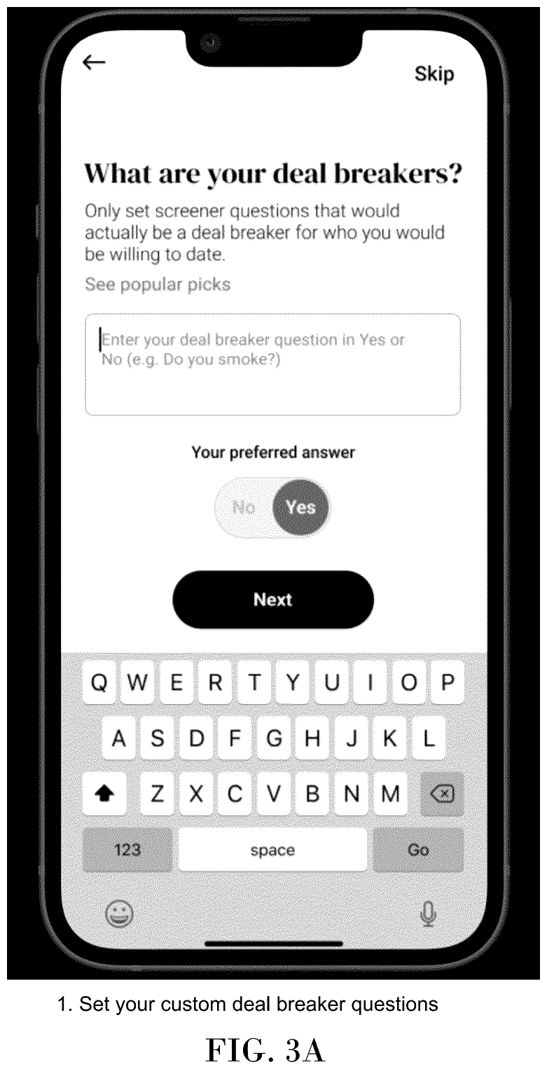

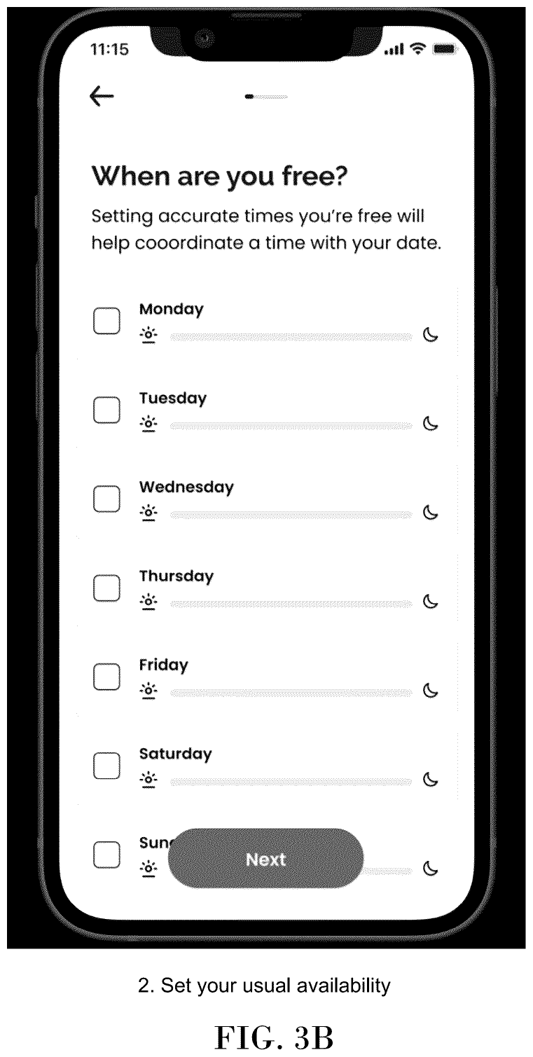

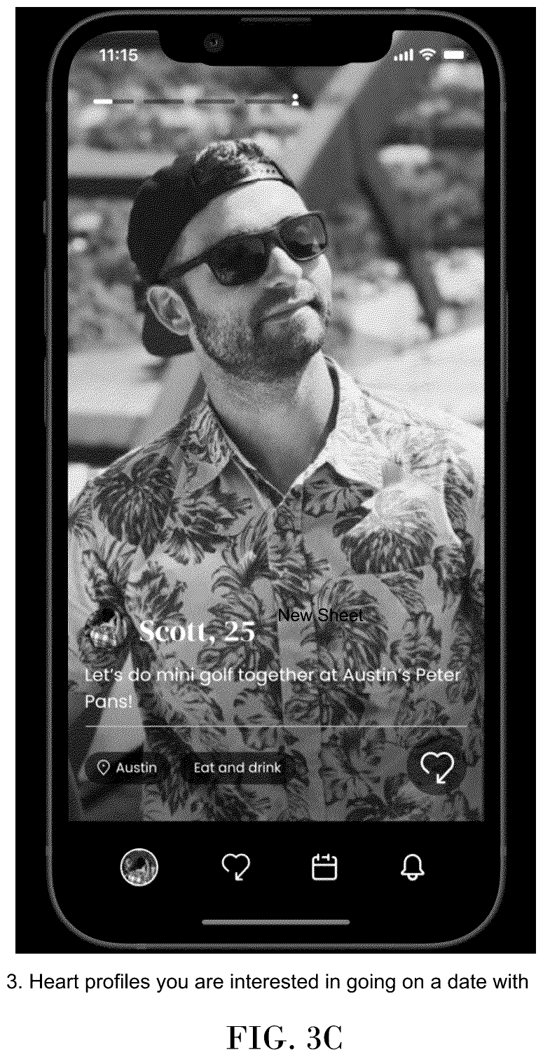

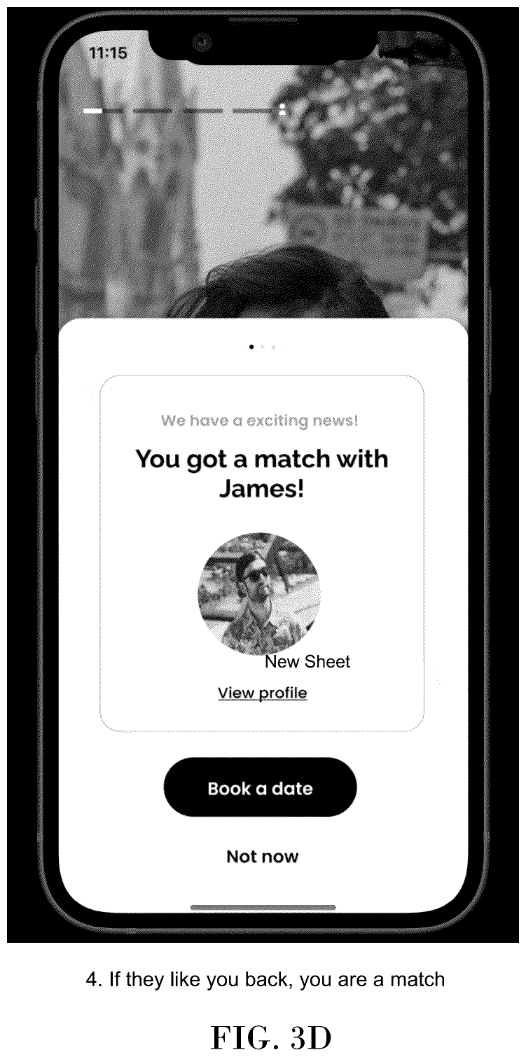

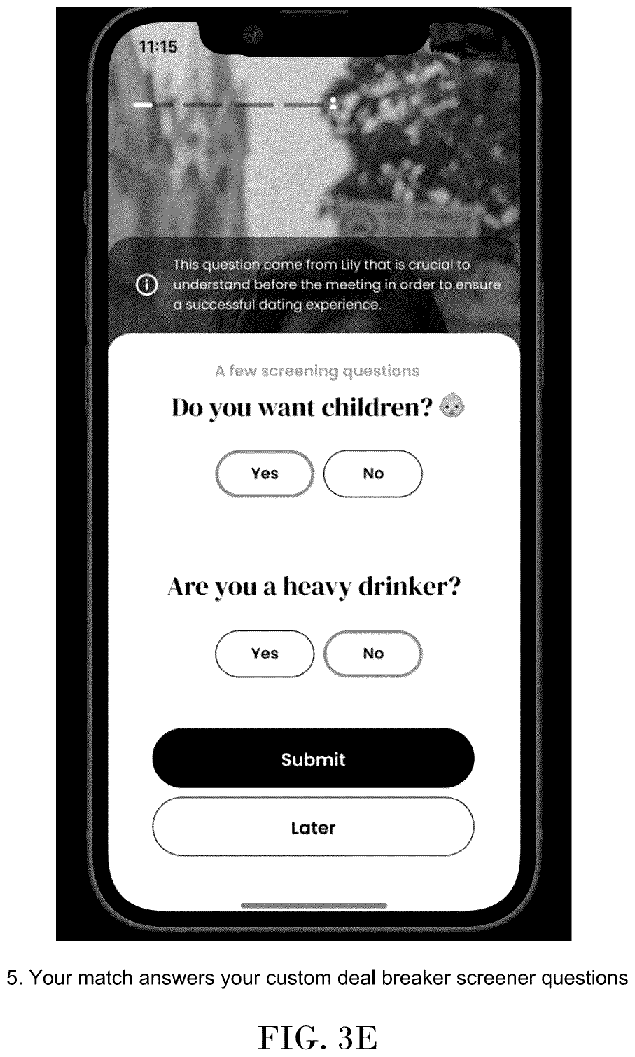

FIGS. 3A-E show an exemplary user journey for users who will screen other users, according to some embodiments. In some embodiments, the user who screens other will be women. In the example shown, the user journey is that of a woman named Sandra who is setting up an account with the online matching platform. At step 1 shown in FIG. 3A, Sandra sets custom deal breaker screener questions to which she wants interested persons to answer. In one example, Sandra selects the screener questions “Do you want children?” and “Are you a heavy drinker?” The user selects her favored answer of “yes” for “Do you want children?” and selects the answer “no” for “Are you a heavy drinker?” screener questions. Interested users will have to answer “yes” to “Do you want children?” questions and “no” to “Are you a heavy drinker?” to successfully match with Sandra.

Next, in step 2 shown in FIG. 3B, Sandra sets her usual availability. As shown, Sandra may choose different times she is generally available to go out on dates depending on the day. In step 3 shown in FIG. 3C, Sandra may begin the swiping process where they indicate that they are interested or not interested in other profiles. Here, Sandra may tap the heart to indicate that she is interested in James. In step 4 shown in FIG. 3D, Sandra is shown that James is also interested in her. In step 5 shown in FIG. 3E, James is being screened for the deal-breaker questions that Sandra set earlier. As shown, James answers the deal-breaker questions “Do you want children?” and “Are you a heavy drinker?”

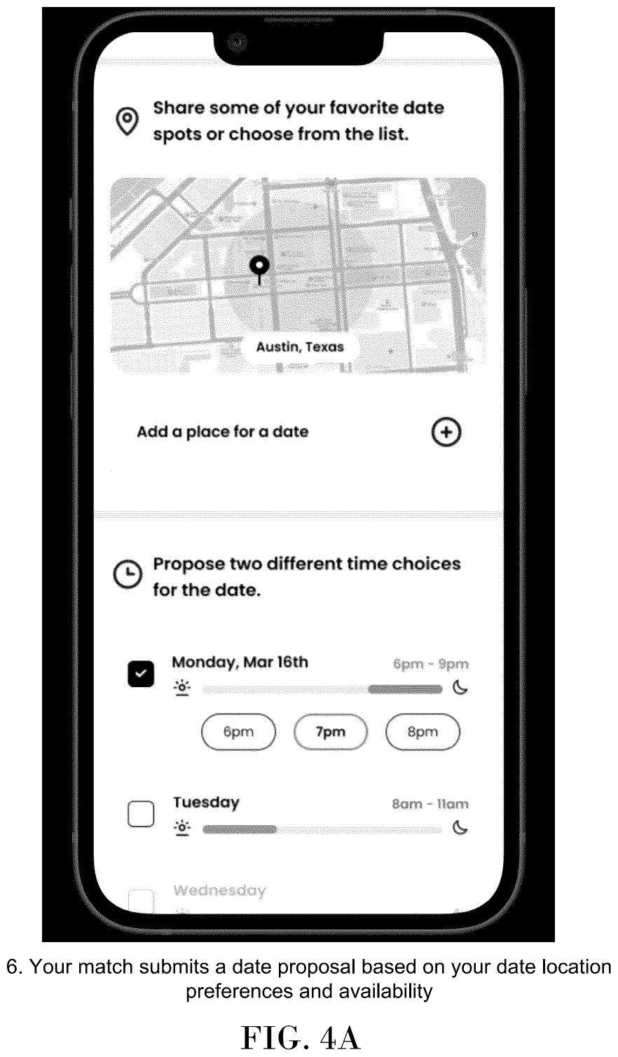

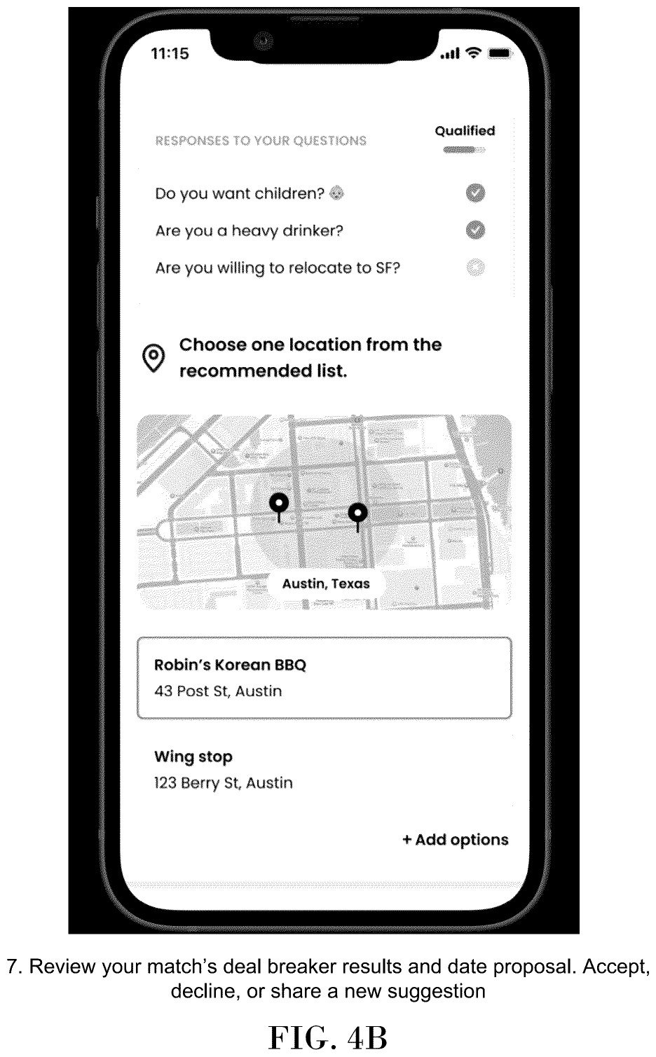

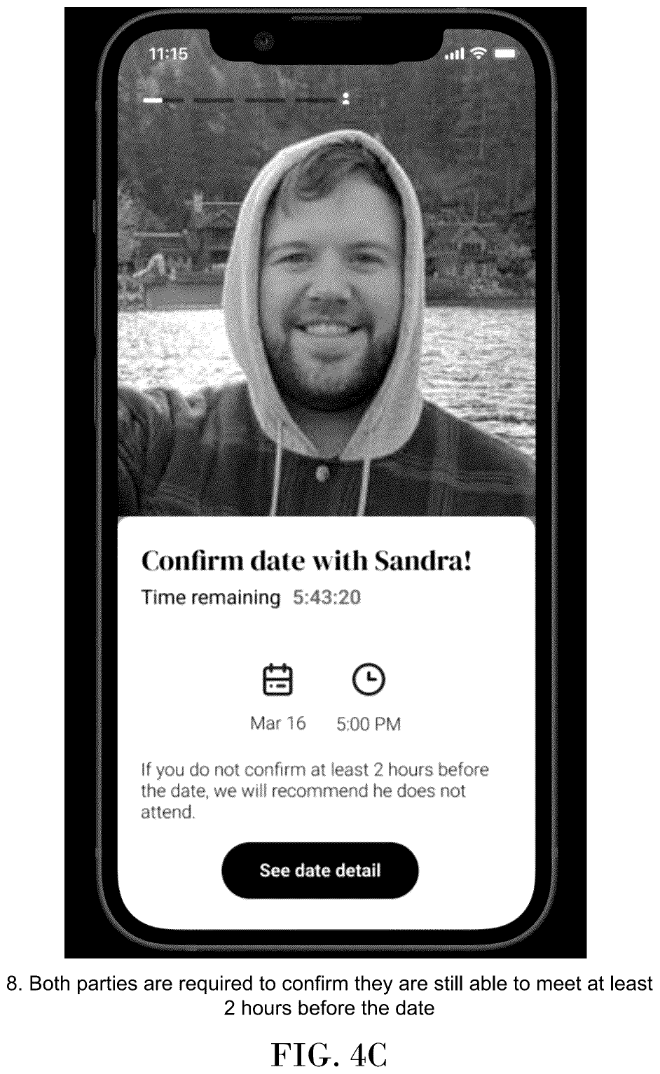

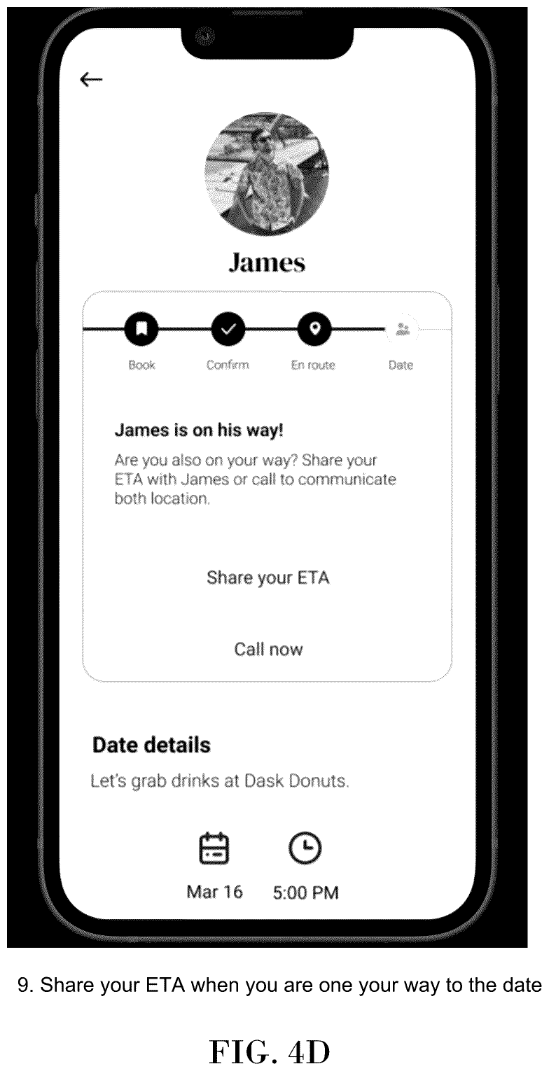

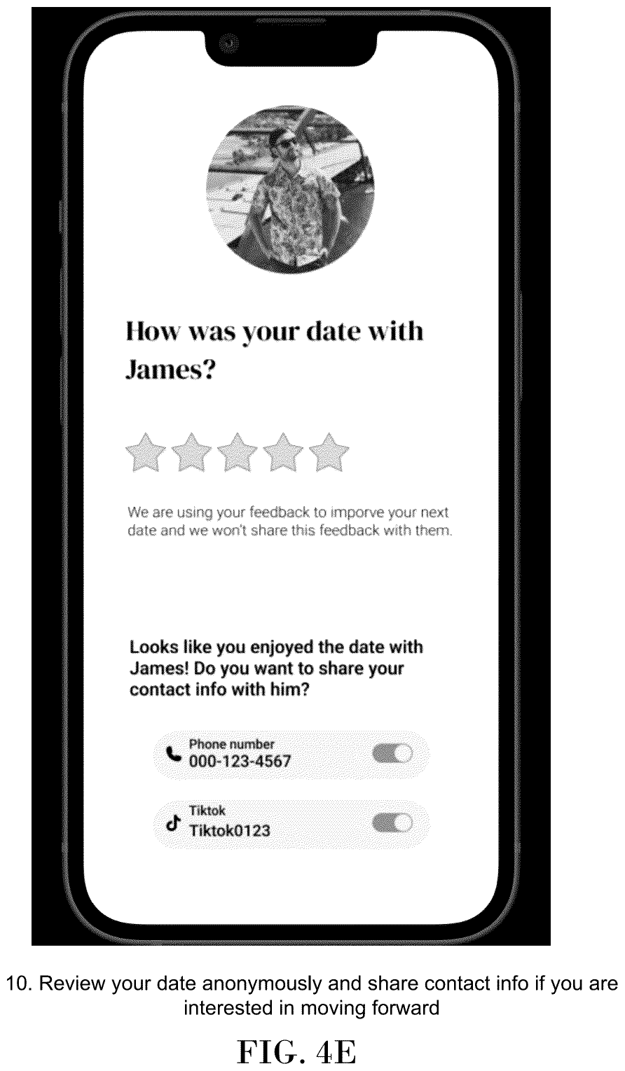

FIGS. 4A-E continues to show the exemplary user journey, according to some embodiments. In step 6 shown in FIG. 4A, James proposes two meeting dates, times, and locations for dates based on Sandra's date and location preferences. In step 7 shown in FIG. 4B, James's proposed meetings are displayed to Sandra, who can then choose which proposed meeting she prefers. As shown, Sandra confirms that she wishes to go to Robin's Korean BBQ. On this screen, Sandra can review James's deal-breaker questions and, if needed, decline, or share a new suggestion. At step 8 shown in FIG. 4C, both parties are required to confirm their continued intent and ability to meet at least 2 hours before the scheduled date. At step 9 shown in FIG. 4D, both parties can share their estimated time of arrival (ETA) to their match.

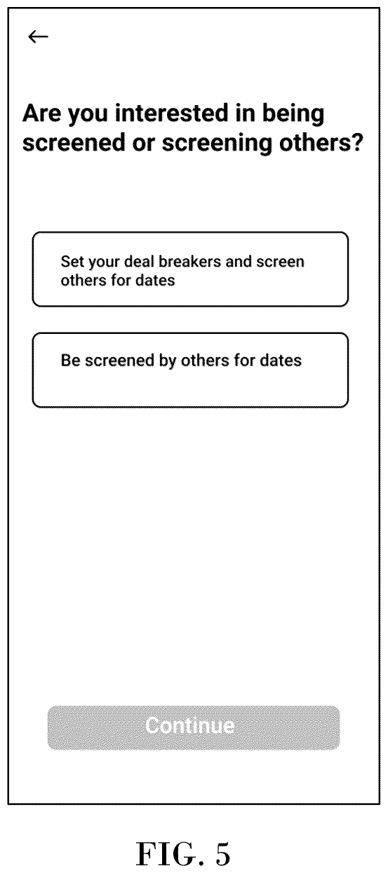

FIG. 5 shows an exemplary interface for users to select whether they want to screen or be screened by other users, according to some embodiments. For homosexual users, the bifurcation of having men be screened and having women do the screening does not work. Instead, the online matching platform asks homosexual users whether they wish to be screened or whether they want to screen others.

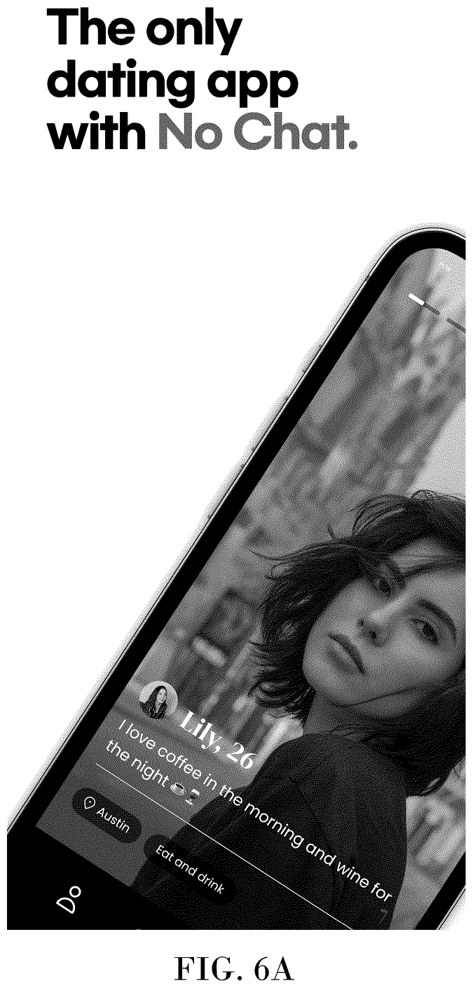

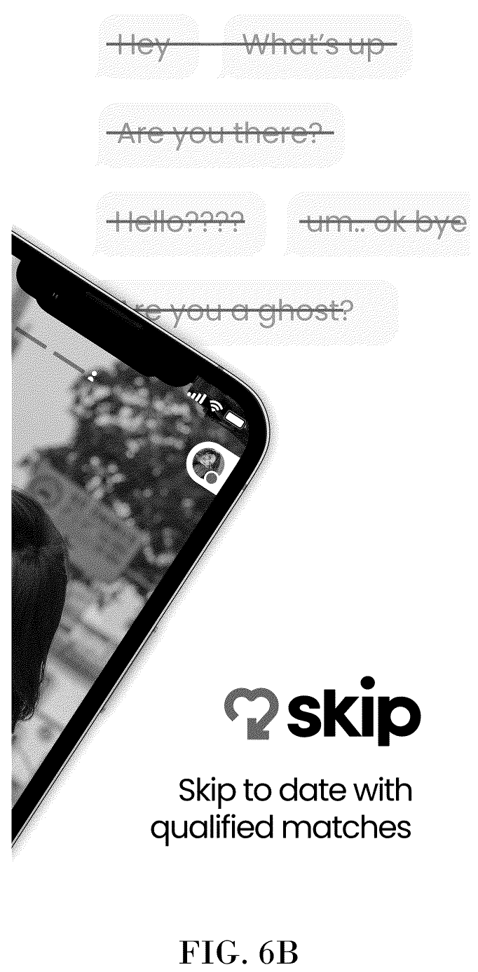

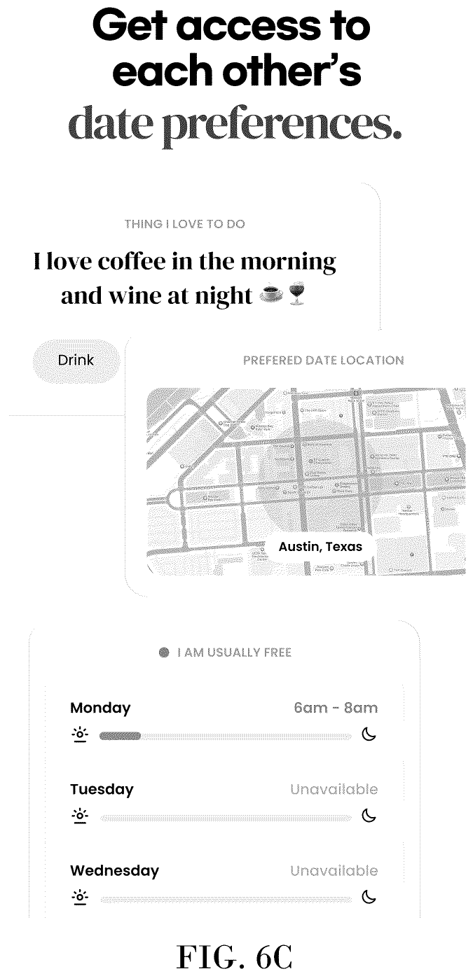

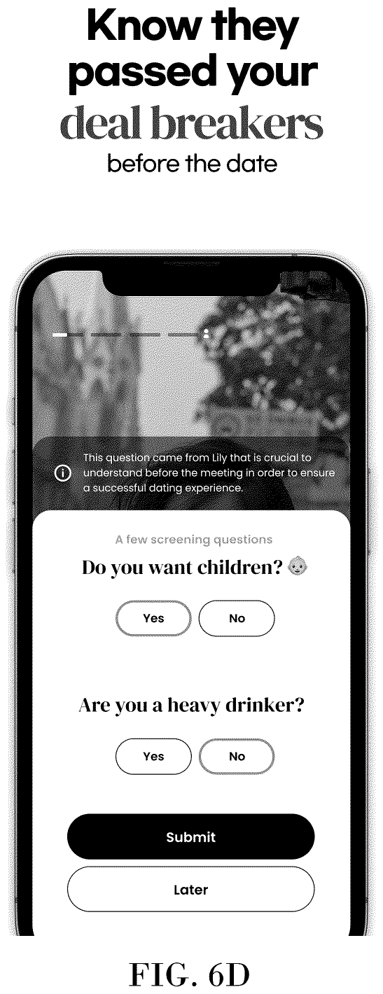

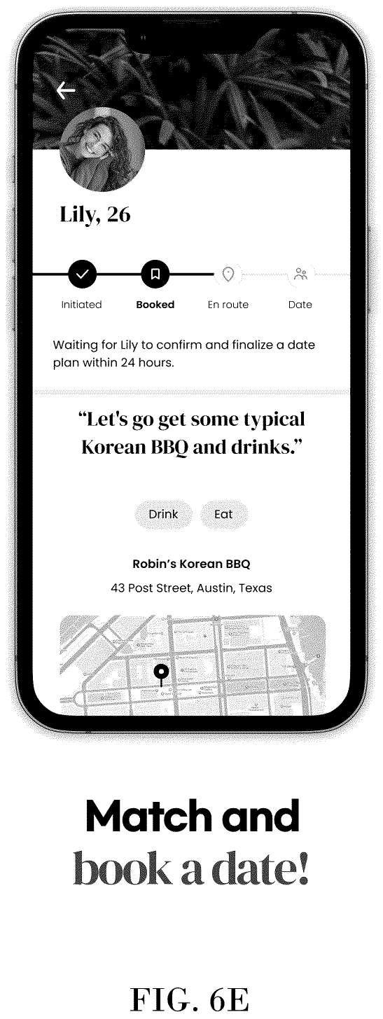

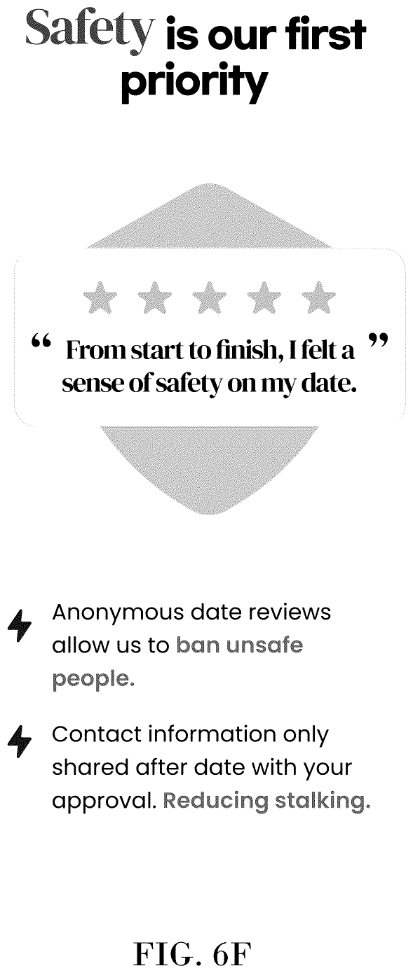

FIGS. 6A-F show exemplary screen captures of the online matching platform mobile application, according to some embodiments.

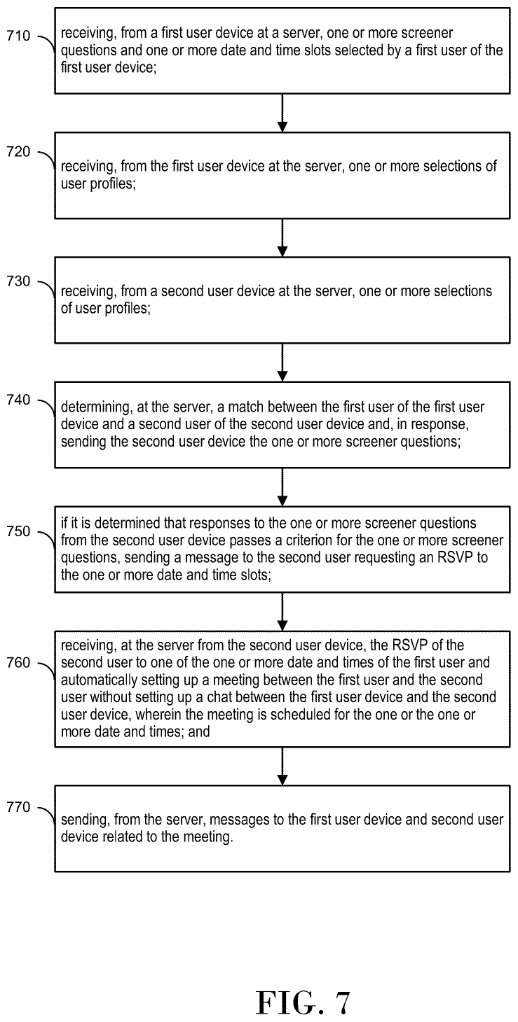

FIG. 7 shows an overall flow of a matching and scheduling process performed by the online matching platform, according to some embodiments. The embodiment that is shown provides computer-implemented method of setting up a meeting between a first user and a second user of a mobile application. The method includes receiving, from a first user device at a server, one or more screener questions and one or more date and time slots selected by a first user of the first user device. The method also includes receiving, from the first user device at the server, one or more selections of user profiles. The method then provides for receiving, from a second user device at the server, one or more selections of user profiles. The method also provides for determining, at the server, a match between the first user of the first user device and a second user of the second user device and, in response, sending the second user device the one or more screener questions. If it is determined that responses to the one or more screener questions from the second user device passes a criterion for the one or more screener questions, the method provides for sending a message to the second user requesting an RSVP to the one or more date and time slots. The method further provides for receiving, at the server from the second user device, the RSVP of the second user to one of the one or more date and times of the first user and automatically setting up a meeting between the first user and the second user without setting up a chat between the first user device and the second user device, wherein the meeting is scheduled for the one of the one or more date and times to which the second user RSVP′d. Moreover, the method provides sending, from the server, messages to the first user device and second user device related to the meeting.

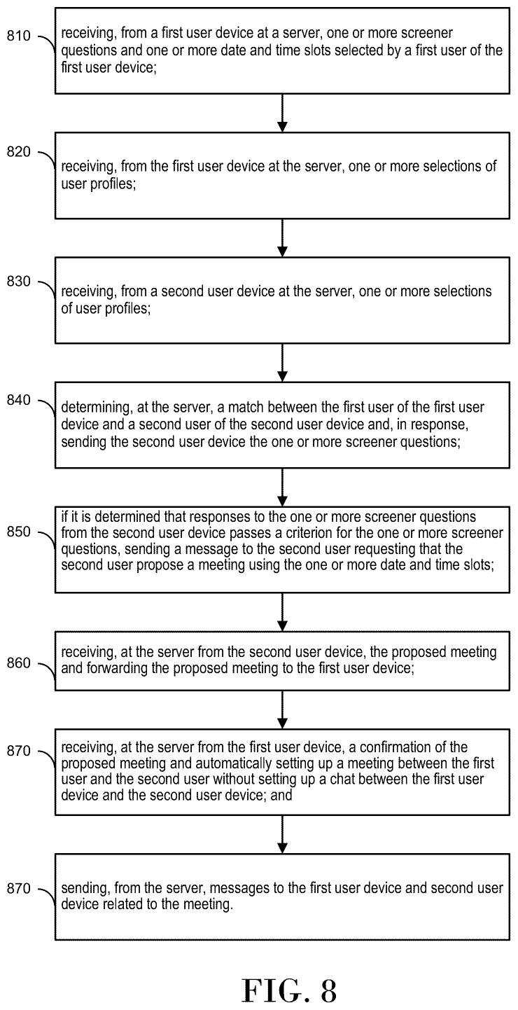

FIG. 8 shows another overall flow of a matching and scheduling process performed by the online matching platform, according to other embodiments. The embodiment that is shown provides computer-implemented method of setting up a meeting between a first user and a second user of a mobile application. The method includes receiving, from a first user device at a server, one or more screener questions and one or more date and time slots selected by a first user of the first user device. The method also includes receiving, from the first user device at the server, one or more selections of user profiles. The method then provides for receiving, from a second user device at the server, one or more selections of user profiles. The method also provides for determining, at the server, a match between the first user of the first user device and a second user of the second user device and, in response, sending the second user device the one or more screener questions. If it is determined that responses to the one or more screener questions from the second user device passes a criterion for the one or more screener questions, the method provides for sending a message to the second user requesting the second user propose a meeting (e.g., a date, time, and location) using one of the date and time slots preferred by the first user. The method also provides receiving, at the server from the second user device, the proposed meeting and forwarding the proposed meeting to the first user device. Next, the method provides receiving at the server from the first user device, a confirmation of the proposed meeting and automatically setting up a meeting between the first user and the second user without setting up a chat between the first user device and the second user device. Finally, the method provides sending, from the server, messages to the first user device and second user device related to the meeting.

The above description illustrates various embodiments of the present disclosure along with examples of how aspects of the present disclosure may be implemented. The above examples and embodiments should not be deemed to be the only embodiments, and are presented to illustrate the flexibility and advantages of various embodiments of the present disclosure as defined by the following claims. Based on the above disclosure and the following claims, other arrangements, embodiments, implementations and equivalents will be evident to those skilled in the art and may be employed without departing from the spirit and scope of the present disclosure as defined by the claims.

What is claimed is:

1. A computer-implemented method of setting up a meeting between a first user and a second user of a mobile application, comprising:
receiving, from a first user device at a server, one or more screener questions and one or more date and time slots selected by a first user of the first user device;
receiving, from the first user device at the server, one or more selections of user profiles;
receiving, from a second user device at the server, one or more selections of user profiles;
determining, at the server, a match between the first user of the first user device and a second user of the second user device and, in response, sending the second user device the one or more screener questions;
if it is determined that responses to the one or more screener questions from the second user device passes a criterion for the one or more screener questions, sending a message to the second user requesting that the second user propose a meeting using the one or more date and time slots;
receiving, at the server from the second user device, the proposed meeting and forwarding the proposed meeting to the first user device;
receiving, at the server from the first user device, a confirmation of the proposed meeting and automatically setting up a meeting between the first user and the second user without setting up a chat between the first user device and the second user device; and
sending, from the server, messages to the first user device and second user device related to the meeting.

2. The computer-implemented method of claim 1, wherein the proposed meeting comprises two or more proposed meetings and wherein the confirmation of the proposed meeting comprises a selection of one of the two or more proposed meetings.

3. The computer-implemented method of claim 1, wherein said forwarding the proposed meeting to the first user device includes providing an option to decline, accept, or suggest a new meeting.

4. The computer-implemented method of claim 1, further comprising:
sending, to the first user device, a request for confirmation that the first user continues to be able to attend the meeting;
sending, to the second user device, a request for confirmation that the second user continues to be able to attend the meeting; and
if it is determined within a predetermined time period ahead of a time of the meeting that one or both of the first user and second user has not successfully confirmed their continued ability to attend the meeting, sending a recommendation to the first user device or second user device to not attend the meeting.

5. The computer-implemented method of claim 1, wherein responses to the one or more screener questions passes the criterion when each response matches a preferred response set by the first user.

6. The computer-implemented method of claim 1, wherein selection of user profiles is performed using swiping.

7. The computer-implemented method of claim 1, further comprising:
receiving, at the server from the first user device, a first estimated time of arrival (ETA) to the meeting and sharing the first ETA with the second user device; and
receiving, at the server from the second user device, a second ETA to the meeting and sharing the second ETA with the first user device.

8. A non-transitory machine-readable medium storing a program executable by at least one processing unit of a device, the program comprising sets of instructions for:
receiving, from a first user device at a server, one or more screener questions and one or more date and time slots selected by a first user of the first user device;
receiving, from the first user device at the server, one or more selections of user profiles;
receiving, from a second user device at the server, one or more selections of user profiles;
determining, at the server, a match between the first user of the first user device and a second user of the second user device and, in response, sending the second user device the one or more screener questions;
if it is determined that responses to the one or more screener questions from the second user device passes a criterion for the one or more screener questions, sending a message to the second user requesting that the second user propose a meeting using the one or more date and time slots;
receiving, at the server from the second user device, the proposed meeting and forwarding the proposed meeting to the first user device;
receiving, at the server from the first user device, a confirmation of the proposed meeting and automatically setting up a meeting between the first user and the second user without setting up a chat between the first user device and the second user device; and
sending, from the server, messages to the first user device and second user device related to the meeting.

9. The non-transitory machine-readable medium of claim 8, wherein the proposed meeting comprises two or more proposed meetings and wherein the confirmation of the proposed meeting comprises a selection of one of the two or more proposed meetings.

10. The non-transitory machine-readable medium of claim 8, wherein said forwarding the proposed meeting to the first user device includes providing an option to decline, accept, or suggest a new meeting.

11. The non-transitory machine-readable medium of claim 8, further comprising sets of instructions for:
sending, to the first user device, a request for confirmation that the first user continues to be able to attend the meeting;
sending, to the second user device, a request for confirmation that the second user continues to be able to attend the meeting; and
if it is determined within a predetermined time period ahead of a time of the meeting that one or both of the first user and second user has not successfully confirmed their continued ability to attend the meeting, sending a recommendation to the first user device or second user device to not attend the meeting.

12. The non-transitory machine-readable medium of claim 8, wherein responses to the one or more screener questions passes the criterion when each response matches a preferred response set by the first user.

13. The computer-implemented method of claim 8, wherein selection of user profiles is performed using swiping.

14. The computer-implemented method of claim 1, further comprising sets of instructions for:
receiving, at the server from the first user device, a first estimated time of arrival (ETA) to the meeting and sharing the first ETA with the second user device; and
receiving, at the server from the second user device, a second ETA to the meeting and sharing the second ETA with the first user device.

15. A system comprising:
a set of processing units; and
a non-transitory machine-readable medium storing instructions that when executed by at least one processing unit in the set of processing units cause the at least one processing unit to:
receive, from a first user device at a server, one or more screener questions and one or more date and time slots selected by a first user of the first user device;
receive, from the first user device at the server, one or more selections of user profiles;
receive, from a second user device at the server, one or more selections of user profiles;
determine, at the server, a match between the first user of the first user device and a second user of the second user device and, in response, send the second user device the one or more screener questions;
if it is determined that responses to the one or more screener questions from the second user device passes a criterion for the one or more screener questions, send a message to the second user requesting that the second user propose a meeting using the one or more date and time slots;
receive, at the server from the second user device, the proposed meeting and forward the proposed meeting to the first user device;
receive, at the server from the first user device, a confirmation of the proposed meeting and automatically set up a meeting between the first user and the second user without setting up a chat between the first user device and the second user device; and
send, from the server, messages to the first user device and second user device related to the meeting.

16. The system of claim 15, wherein the proposed meeting comprises two or more proposed meetings and wherein the confirmation of the proposed meeting comprises a selection of one of the two or more proposed meetings.

17. The system of claim 15, wherein said forwarding the proposed meeting to the first user device includes providing an option to decline, accept, or suggest a new meeting.

18. The system of claim 15, wherein the non-transitory machine-readable medium further stores instructions that when executed by at least one processing unit in the set of processing units cause the at least one processing unit to
send, to the first user device, a request for confirmation that the first user continues to be able to attend the meeting;
send, to the second user device, a request for confirmation that the second user continues to be able to attend the meeting; and
if it is determined within a predetermined time period ahead of a time of the meeting that one or both of the first user and second user has not successfully confirmed their continued ability to attend the meeting, send a recommendation to the first user device or second user device to not attend the meeting.

19. The system of claim 15, wherein responses to the one or more screener questions passes the criterion when each response matches a preferred response set by the first user.

20. The system of claim 15, wherein the non-transitory machine-readable medium further stores instructions that when executed by at least one processing unit in the set of processing units cause the at least one processing unit to:
receive, at the server from the first user device, a first estimated time of arrival (ETA) to the meeting and share the first ETA with the second user device; and
receive, at the server from the second user device, a second ETA to the meeting and share the second ETA with the first user device.
